(19) United States
(12) Patent Application Publication
(10) Pub. No.: US 2001/0042448 A1
(43) Pub. Date: Nov. 22, 2001

(54) Dual-surface cooking system with motorized heads

(76) Inventors: Alexandre Menektchiev, Harvard, IL (US); Michael E. Mirshak, Love Park, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/859,554

(22) Filed: May 17, 2001

Related U.S. Application Data
(60) Provisional application No. 60/205,750, filed on May 19, 2000.

(51) Int. Cl. A47J 44/00

(52) U.S. Cl. 99/372; 426/523

(57) ABSTRACT

The present invention comprises an automated chromium-covered dual surface cooking system comprising one or more electric actuators that raise and lower one or more cooking heads before and after foodstuffs are cooked and audibly tell the user when the cooking is completed. The cooking system further comprises LED timer and temperature displays and a leveling system that maintains the upper cooking surface a requisite distance from the food to be grilled.

### CROSS REFERENCE TO RELATED PATENT APPLICATIONS

This patent application is a non-provisional application claiming the benefit of a co-pending U.S. Provisional Patent No. 60/205,750, filed May 19, 2000.

### FIELD OF THE INVENTION

The present invention relates to a dual surface cooking system, and more particularly, to a cooking device comprising three motorized separately-heated upper heads and a single flat chromium-covered lower cooking surface.

### BACKGROUND OF THE INVENTION

Dual surface or “top side” cookers are widely popular in commercial food service locations for materially reducing the cooking time and lowering the amount of user attention required during the production of hamburger and other foodstuffs. However, many difficulties are associated with dual surface or top-side cooking of various food products including obtaining adequate volume of food production and providing the upper surface at the proper height in order not to crush the food but allow proper heat transfer.

Accordingly, it is one object of the present invention to provide a cooking system that increases the speed and the volume that food is commercially produced. Other objects and advantages of the invention will be apparent from the following detailed description and the accompanying drawings.

### SUMMARY OF THE INVENTION

The present invention comprises an automated dual surface cooking system comprising one or more electric actuators that raise and lower one or more cooking heads before and after foodstuffs are cooked and audibly tell the user when the cooking is completed. The cooking system further comprises LED timer and temperature displays and a leveling system that maintains the upper cooking surface a requisite distance from the food to be grilled.

### BRIEF DESCRIPTION OF THE ILLUSTRATIVE EMBODIMENTS

Other objects and advantages of the invention will become apparent upon reading the following description of illustrative embodiments and upon reference to these drawings.

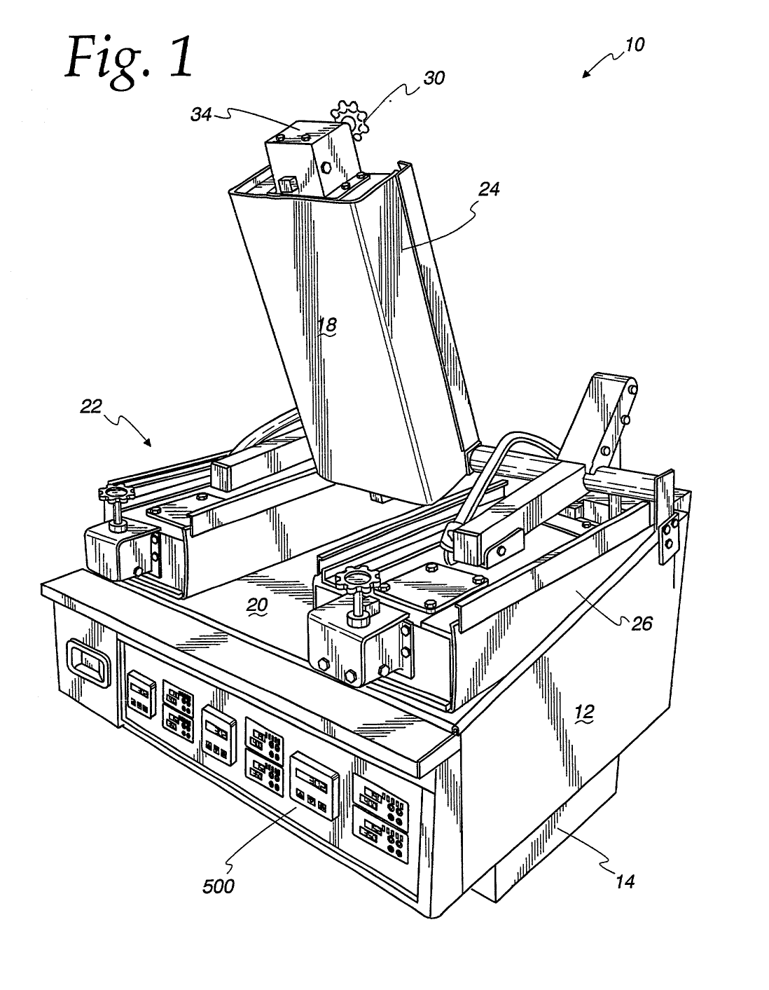

FIG. 1 displays a perspective front view of the dual-surface cooking system of the present invention with one raised head and two lowered heads;

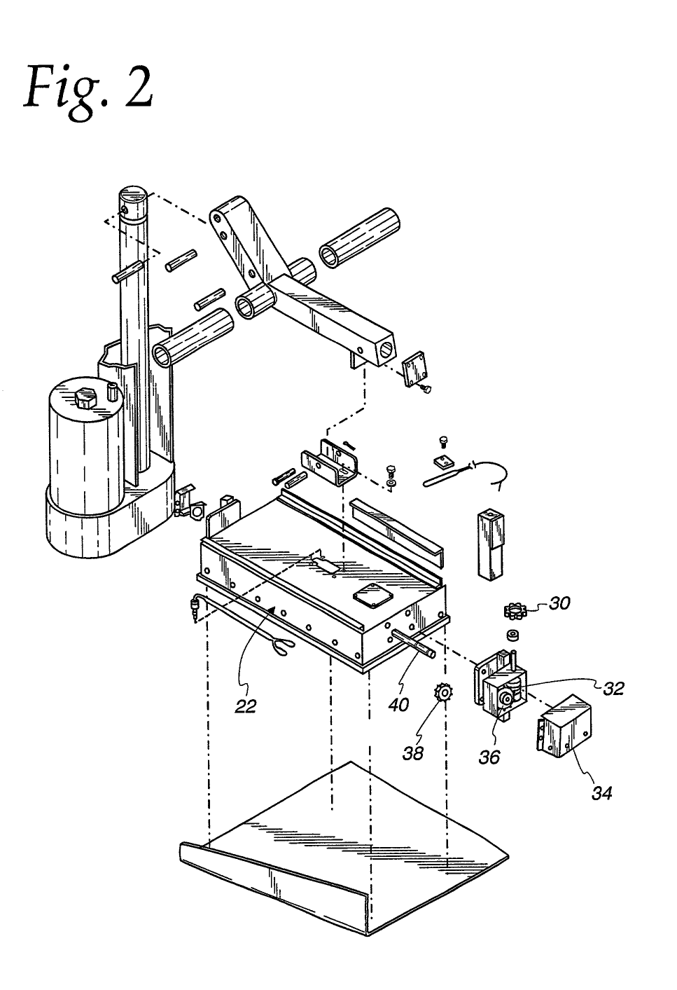

FIG. 2 displays an exploded perspective of the dual-surface cooking system;

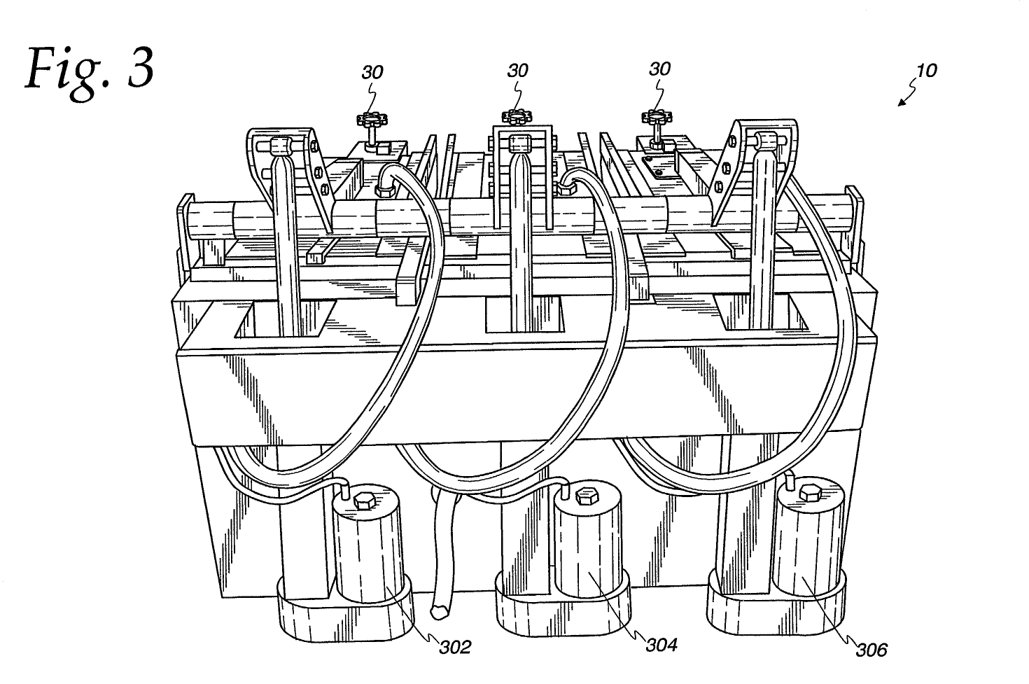

FIG. 3 displays a perspective rear view of the dual-surface cooking system with three lowered heads;

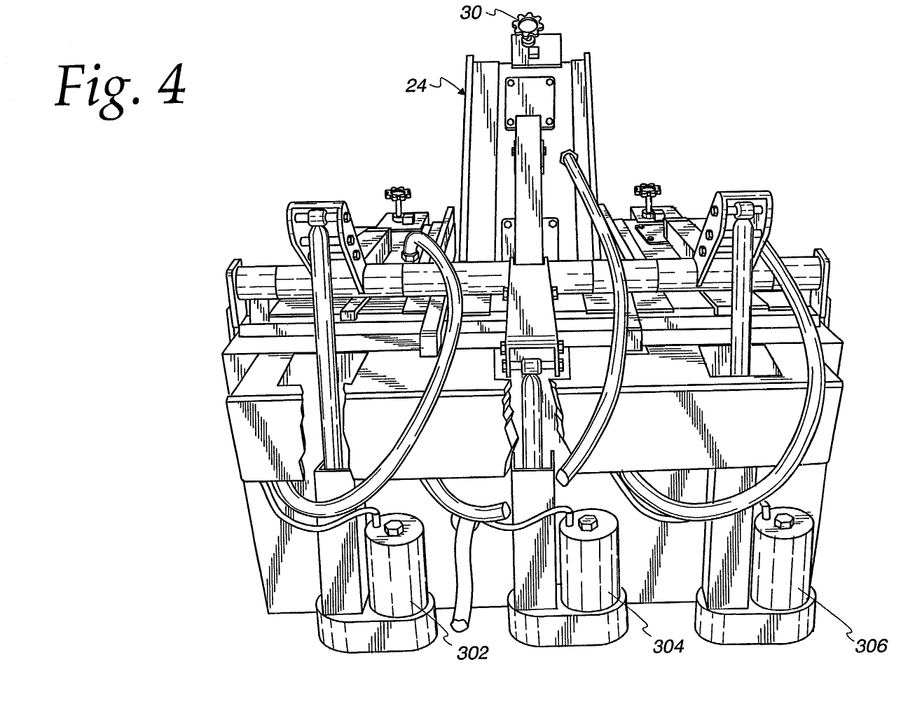

FIG. 4 displays another perspective rear view of the dual-surface cooking system; and

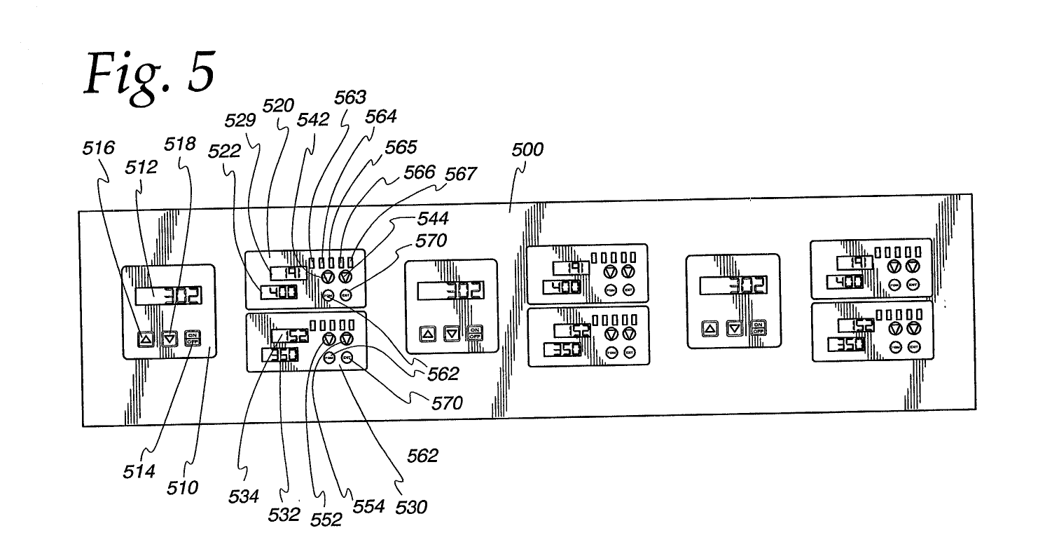

FIG. 5 displays the control panel and LED displays on the front of the dual-surface cooking system.

While the present invention is susceptible to various modifications and alternative forms, several embodiments will herein be described in detail. It should be understood, however, that it is not intended to limit the invention to the particular forms disclosed, but on the contrary, the invention is to cover all modifications, equivalents and alternatives falling within the spirit and scope of the invention as defined by the appended claims.

### DETAILED DESCRITION OF ILLUSTRATIVE EMBODIMENTS

As shown in FIG. 1, a dual surface or “top side” cooking system 10 comprises a body 12 having one or more legs 14 for supporting a cooking grill 16. The cooking grill 16 includes two cooking sites: upper cooking site 18 and lower cooking site 20 (that are heated by well-known means). Upper cooking site 18 includes three separate cooking heads: a first cooking head 22, a second cooking head 24, and a third cooking head 26.

The upper cooking site 18 is positioned over and above fixed lower cooking site 20. The motorized first cooking head 22, the second cooking head 24 and the third cooking head 26 are suspended for accurate movement between an upper, open cooking position and a lower cooking position. The lower cooking position allows the surfaces of each of the cooking heads to be positioned close to lower cooking site 20. The separation between the cooking heads and the lower cooking site allows for the placement of foodstuffs such that the cooking heads can heat the top surface of the foodstuff while the lower cooking site can simultaneously heat the opposing side of the same foodstuff. The first, second and third cooking heads 22, 24, 26 are movable in an arcuate path between the upper cooking position and the lower cooking position in response to electric actuators that are able to separately raise and lower each cooking head in response to the depression of a button on the front of the dual-surface cooking system. Each of the cooking heads 22, 24, 26 is generally rectangular in shape and has substantial weight. Each head has a flat cooking surface on its underside that assumes generally a parallel attitude with respect to the lower cooking site 20 when the cooking heads 22, 24, 26 are in the closed position. Those skilled in the art will appreciate that the cooking heads and the lower cooking site 20 include means for heating both cooking surfaces. It is contemplated in accordance with the present invention that the cooking heads can each be preset at a different height in order to allow the user to cook foodstuffs of different heights.

The cooking heads 22, 24, 26 are pivotally connected at the rear of the dual-surface cooking system. Furthermore, each cooking head includes a height adjuster 30 at the front of the head to change the space between the lower cooking site 18 and the cooking surface of the cooking heads 22, 24, 26. It is necessary for operators to be able to change the height between the lower site 18 and the cooking heads 22, 24, 26 depending on the thickness of the foodstuff being prepared. The height adjusters 30 are each rotatable to raise and lower the cooking head to establish the desired distance. As shown in FIG. 2, each cooking head 22, 24, 26 comprises a knob 30, a worm gear 32, a housing cover 34, a worm gear wheel 36, a spur gear 38 and a shaft 40. Within the housing cover 34, a worm engages a worm gear that is affixed to the shaft 40 extending from the front of the cooking head to the rear of the cooking head. It is appreciated that the fineness of the teeth in the gears will determine the degree of accuracy and control that the user has in positioning of the head over the lower cooking site 20. The specific operation of the height adjusters 30 is set forth in further detail in U.S. Pat. No. 5,758,568 to Moravec, which is incorporated herein in its entirety.

All of the cooking surfaces of the present invention are topped with chromium. Chromium-plated cooking surfaces prevent an overabundance of heat from radiating off the cooking surfaces and escaping into the air. Thus, the cooking system of the present invention is able to use less energy and reduce the amount of air conditioning required to cool the environment containing the cooking system of the present invention. Furthermore, the chromium cooking surfaces are much easier to clean than most other types of cooking surfaces, saving the owner many man-hours each day, week and year by reducing the amount of time required to clean the cooking system.

As shown in FIG. 3, electric actuators 302, 304, 306 at the back of the dual-surface cooking system raise and lower the cooking heads 22, 24, 26 respectively, in response to depression of a button on the front of the dual-surface cooking system. Generally, an electric actuator is a mechanism designed to activate process control equipment by use of electronic signals. Specifically, the electric actuator of the present application is a 24 volt direct current (DC) device having an eight inch stroke length. When the start/stop button 514, as shown in FIG. 5, is depressed, the head will receive a signal to move, either from the open to the lowered cooking position or from the lowered to the open cooking position. As shown in FIG. 3, each of the heads 22, 24, 26 is in the lowered, or closed position. Activating the electric actuators 302, 304, 306 signals to the cooking heads 22, 24, 26, respectively, to raise to a predetermined position above the lower cooking site 20. It is contemplated in accordance with the present invention that the user can preset the distance that the heads move away from the lower cooking site based on the amount of available space above the dual-surface cooking system 10 or the type of exhaust or ventilation that is required. FIG. 4 displays a perspective rear view of the dual-surface cooking system.

As shown in FIG. 5, the control panel 500, located on the front of the dual-surface cooking system 10, comprises, for each cooking head, a cooking time panel 510, a LED display for the cooking timer 512, a start/stop button 514 for the cooking timer, up and down controllers to preset the desired cooking time 516 and 518 respectively, a cooking temperature panel for the upper cooking surface 520, a cooking temperature panel for the lower cooking surface 530, a LED display for the preset temperature of the upper grilling surface 522 and the current temperature of the upper grilling surface 529, a LED display for the preset temperature of the lower grilling surface and the current temperature of the lower grilling surface 534, up and down controllers 542 and 544 to preset the desired cooking temperature for the upper cooking surface, up and down controller 552 and 554 to preset the desired cooking temperature for the lower cooking surface, and a program button 562 and a plurality of associated LED lights 563, 564, 565, 566, 567 and an exit button 570 for each of the upper and lower cooking surface.

In use, the cooking timer 512 will be preset depending on the type, thickness and density of the food that is being prepared. The cooking heads will be in the open cooking position in order to manually load the food onto the lower cooking site. The cooking timer 512 is programmable, for example, up to an hour of cooking time in 10-second increments. It is contemplated in accordance with the present invention that other types of times can be used with longer or shorter maximum settings and different incremental values. The user can use the up and down controllers 516 and 518 to preset the cooking time that is desired.

The upper and lower cooking surfaces can be maintained at different temperatures. For this reason, separate controllers exist for the lower and the upper cooking surface. The cooking temperature panel for the upper cooking surface includes a LED display 520 for the preset and current temperatures of the upper grilling surface, up and down controllers 542 and 544 to preset the desired cooking temperature for the upper cooking surface, a program button 562 and a plurality of associated LED lights 563, 564, 565, 566, 567 and an exit button 570 for the upper and lower cooking surface. It is contemplated in accordance with the present invention that the temperature of the upper surface can be controlled by at least two methods. First, the user can preset the desired temperature by use of the up and down temperature controllers. Second, the user can depress the program button 562 to activate the plurality of associated LED lights 563, 564, 565, 566, 567. The first depression of the program button 562 will activate the first program light 563, indicating to the cooking system 10 that the user desired the first manufacturer-preset cooking temperature. Further depressions of the program button 562 will activate other program lights to indicate other temperature-preset programs. Depression of the exit button 570 will return the user to the manual mode of entering the desired temperature and require the user to use the up and down controllers 542 and 544 to set the desired temperature.

The cooking temperature panel for the lower cooking surface includes LED display 530 for the preset and current temperatures of the lower grilling surface, up and down controllers 552 and 554 to preset the desired cooking temperature for the lower cooking surface, a program button and a plurality of associated LED lights and an exit button for the lower cooking surface. Each of the controllers for the lower cooking surface functions in the same manner as the corresponding controller for the upper cooking surface described above. Further, the controllers have only been described in relation to one head and one lower cooking surface area. It is contemplated that the other two sets of cooking areas function in remarkably the same manner.

After presetting the requisite time and temperature, the user depresses the start/stop button 514 to lower the cooking heads 22, 24, 26 into place above the lower cooking site 20. The heads require approximately four (4) seconds to lower into place, depending on the predetermined location of the heads. After the heads lower into place, the cooking time automatically begins and continues until the culmination of the cooking process. At the culmination of this process, an alarm or other audible signal will be generated and the head will be automatically raised. No physical effort is required to move the cooking heads between its up and down positions. The heads require approximately two (2) to three (3) seconds to lift from the lower to the upper position.

While the present invention has been described with reference to the particular embodiments illustrated, those skilled in the art will recognize that many changes and variations may be made thereto without departing from the spirit and scope of the present invention. The embodiments and obvious variations thereof are contemplated as falling within the scope and spirit of the claimed invention.

What is claimed is:

1. A top-side cooking device for the simultaneous cooking of both sides of foodstuffs, said device comprising a first stationary cooking site and an opposing second cooking site, said second cooking site comprising at least one movable section, said movable section being separately raised and lowered by non-manual controls to a desired location above said first cooking site, and a food product located and cooked between said first stationary cooking site and said opposing second cooking site.

2. The top-side cooking device of claim 1, wherein said movable section of said second cooking site is movable in an arcuate path.

3. The top-side cooking device of claim 1, wherein said non-manual controls are electric actuators.

4. The top-side cooking device of claim 3, wherein said electric actuators are powered by 24 volt direct current devices.

5. The top-side cooking device of claim 1, wherein said second cooking site comprises three movable sections.

6. The top-side cooking device of claim 1, wherein the temperature of said first cooking site and of each of said sections of said second cooking site is individually controlled.

7. The top-side cooking device of claim 6, wherein the temperature of said first cooking site and of each of said sections of said second cooking site is selected by up and down selectable elements located on at least one display of said device.

8. The top-side cooking device of claim 6, wherein the temperature of said first cooking site and of each of said sections of said second cooking site is manipulated by predetermined programs selectable on at least one display of said device.

9. The top-side cooking device of claim 8, wherein the temperature of said first cooking site and of each of said sections of said second cooking site is manipulated by predetermined programs selectable via touchable elements on said displays.

10. The top-side cooking device of claim 8, wherein the temperature of said first cooking site and of each of said sections of said second cooking site is selected from a plurality of preselected programs.

11. The top-side cooking device of claim 1, wherein at least one of said first cooking site and said second cooking site is covered with chromium.

12. A method of cooking foodstuffs on a top-side cooking device comprising a first and a second cooking site, said second cooking site comprising at least one movable section, said method comprising:
a) placing said foodstuffs on said first cooking site;
b) non-manually setting the time and/or the temperature of said first cooking site and said second cooking site;
c) arranging at least one section of said second cooking site above said foodstuffs so that said movable section of said second cooking site opposes said first site;
d) cooking said foodstuffs with heat emanating from one or both of said first cooking site and said movable section of said second cooking sites; and
e) raising said movable section of said second cooking site using non-manual means.

13. The method of claim 12, further comprising generating an audible alarm signal to indicate the completion of said step of cooking.

14. The method of claim 13, wherein said step of generating an audible alarm signal further automatically raises said movable section of said second cooking site.

15. The method of claim 12, wherein said step of non-manually setting the time and/or temperature further includes automatically lowering said movable section of said second cooking site above and opposing said first cooking site.

16. The method of claim 12, wherein said step of non-manually setting the time and/or temperature further includes depressing a touchable element on said top-side cooking device.

17. The method of claim 12, wherein said at least one section comprises three sections.

18. The method of claim 12, wherein said movable section of said second cooking site is movable in an arcuate path.

19. The method of claim 12, wherein said movable section of said second cooking site is controlled by at least one electric actuator.

20. The method of claim 19, wherein said electric actuator is powered by a 24-volt direct current devices.

21. The method of claim 17, wherein the temperature of said first cooking site and of each of said sections of said second cooking site is individually controlled.

22. The method of claim 21, wherein the temperature of said first cooking site and of each of said sections of said second cooking site is selected by up and down selectable elements located on at least one display of said device.

23. The method of claim 21, wherein the temperature of said first cooking site and of each of said sections of said second cooking site is manipulated by predetermined programs selectable on at least one display of said device.

24. The method of claim 23, wherein the temperature of said first cooking site and of each of said sections of said second cooking site is manipulated by predetermined programs selectable via touchable elements on said displays.

25. The method of claim 23, wherein the temperature of said first cooking site and of each of said sections of said second cooking site is selected from a plurality of preselected programs.

26. The method of claim 12, wherein at least one of said first and said second cooking site is topped with chromium.
